(19) United States
(12) Patent Application Publication
(10) Pub. No.: US 2006/0020403 A1
(43) Pub. Date: Jan. 26, 2006

(54) Device and method for real time direct measurement of the proportion and flow-rate of a multi-component complex fluid

(76) Inventor: Daniel J. Pusiol, Cordoba (AR)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/176,613

(22) Filed: Jul. 7, 2005

(30) Foreign Application Priority Data
Jul. 8, 2004 (AR) P04 01 02415

(51) Int. Cl. G01F 1/00

(52) U.S. Cl. 702/45

(57) ABSTRACT

A device for the real time direct measuring of the proportion and flow-rate of the different components which conform a multi-component complex fluid, which device comprises a set of mutually associated control computer, derivation device and electronic measuring device, the derivation device being connected to a plurality of sensor assemblies through which said multi-component complex fluid circulates.

### FIELD OF THE INVENTION

The present invention relates to a device and method for the real time direct measurement of the proportion and flow-rate of different components conforming a multi-component complex fluid, with an arrangement of production lines using said device and a measurement method associated to said production lines arrangement.

### BACKGROUND

A method and device able to directly measure in real time pure oil production of a production line has not yet been developed. The method which is typically used consists of the deviation of the production into a temporal storage tank, collection of the production-generally on a daily basis-after components have undergone a gravimetic separation, and measurement of relative volumes. At present there exist multiple implementing problems as it is not possible to perform a complete separation of the blend components, due to the formation of a water-oil interphase which can be as much as 1 m high, or because after a natural decantation takes place, there is always left a residual quantity of water-oil emulsion. Should it be possible to separate both components properly, devices used in order to measure the interphase volume are difficult to implement in practice. Further, it is only possible to control each oil well individual production with a frequency of at most once a month.

Upon the application of real time direct measurements techniques to hydrocarbon fluids consisting of a multiphase composed by a generally heterogeneous blend of oil, water and gas, special consideration should be given to the fact that gas tends to flow at a rate higher than that of liquid components. It is thus necessary to measure gas flow separately from liquid components, or else, to measure such flow-rate after all of the multi-component complex fluid components have been adequately mixed.

Further, there exist other more advanced techniques, such as the Venturi tube, the Coriolis principle, the ultrasound measurement, gamma rays and Nuclear Magnetic Resonance (NMR).

The first of them is based on the measurement of the pressure difference occurring between the ends of a variable section tube. Measurements using this method strongly depend from the gas dispersed within the mixture or flowing as bubbles. This method, however, is not able to discriminate the various components of a multi-component complex fluid.

Coriolis mass flowmeter is a mechanical design by which the fluid passes through a curve conduct or other medium and produces the vibration of the mechanical parts thereof. The device includes two or more vibration sensors, which are positioned at a certain distance from each other in the fluid direction. Passing flow produces vibrations at predetermined resonance frequencies, which depend on the material and form of said mechanical parts and vary according to the mass flow (see U.S. Pat. No. 4,187,721). It is also possible to derive a phase difference between the resonance difference of both sensors which angle, divided by the resonance frequency v, is proportional to the flow mass proportion (see U.S. Pat. No. 5,648,616, EP-A 866 319). This method, as it involves mechanical interactions, strongly depends from fluid compressibility, which in turn strongly depends from the proportion of both the vein dissolved gas and the gas circulating therethrough in the form of bubbles.

A design lacking moving mechanical parts is that based on ultrasound emission and reception which measure the fluid transit time through the conducting vein. The time taken by the ultrasound wave in arriving to the receiving element since its departure from the emitter, passing through the liquid flow, is proportional to the fluid velocity. Obviously, fluid is used as the coupling substance between the emitting and receiving crystals. Again, in this case gas plays a key role when it comes to evaluate measurement errors. On the one part, bubbles break that coupling and introduce highly significant errors both as regards the transmission time of the acoustic signal and the sound wave attenuation. Even where bubbles are absent, compressibility of the liquid medium strongly depends from the amount of gas dissolved therein, this being a variable which noticeably affects the measuring process and result.

On the other hand, the principle of the Nuclear Magnetic Resonance (NMR) allows both measurements to be performed: i) determination of oil, gas and water proportions of a multi-component complex fluid and, ii) the determination of the flow-rate of each of the components of said multi-component complex fluid.

It is a well known fact that when a set of magnetic moments, such as those possessed by the nuclei of hydrogen atoms, are subject to an external magnetic field, they are polarized and aligned with such field, thus giving way to the formation of a nuclear magnetization bearing a precession movement around the field direction at a characteristic frequency, known as resonance frequency, thus reaching a new equilibrium state in the presence of said magnetic field. The time necessary to attain said equilibrium state, as from the nuclei submission to the magnetic field, is called ASpin-Lattice Relaxation Time@ and it is symbolized as T₁. T₁ value depends from many physical phenomena to which the spins set is subject. Particularly relevant are temperature, fluid movement state, molecule type bearing the hydrogen atom, its molecular dynamics, intra- and inter-molecular interactions, etc. Should said magnetization be separated from the state of equilibrium, as regards the magnetic field direction, its component normal to field decays within a characteristic time T₂, called Spin-Spin Relaxation Time. T₂ value also depends, as T₁, from several physical phenomena (e.g., see A. Abragham, The Principles of Nuclear Magnetism, Oxford University Press, 1996, and C. P. Slichter, Principles of Magnetic Resonance, Springler-Verlag, Berlin, Heidelberg. New York, 1990).

Particularly, in the case of a multi-component complex fluid, such as a heterogeneous oil-water blend, nuclei of oil and water molecules are clearly distinguished by their spin-lattice and spin-spin relaxations. It is thence possible to design a radio-frequency pulse sequence in such a manner that from the response signal provided by a multi-component complex fluid at an oil well, those related to the oil, water and gas can be separated.

On the other hand, literature provides many flow-rate measuring techniques based on the manipulation of the NMR signal in the presence of magnetic field gradients. Magnetic field gradients are used for the spatial coding of fluid mass, allowing measurement of a fluid flow-rate, in combination with an adequate pulse radio-frequency combination (e.g., see P. T. Callaghan, Principles of Nuclear Magnetic Resonance Microscopy, Oxford University Press, 1991, and Song-I Han, O. Marseille, C. Gehlen and B. Blümich, J. Magn. Reson., 152, 87 (2001)).

There exist many patents disclosing methods, not necessarily selective, for multi-component complex fluids, which employ NMR analysis. Among them, there can be cited: 1) Rollwitz, et al., Method and Apparatus for Coal Analysis and Flow Measurements, U.S. Pat. No. 4,531,093; 2) King, et al., Method and Apparatus for Measuring Flow in a Pipe of Conduit@, U.S. Pat. No. 4,536,711 and, 3) Reichwein, Consistency Measuring Device, U.S. Pat. No. 4,866,385.

Devices from the prior art designed to measure flow and/or draw flow maps are based on two widely known principles:

1) Atime of flight@ of saturated or unsaturated spins at the magnetic field of the NMR spectrometer; or

2) the space coding of the flow nuclei spins phase as they are displaced on a magnetic field gradient.

U.S. Pat. No. 4,785,245 describes a flowmeter which employs NMR analysis in order to determinate the fraction of one of the components of a multi-component complex fluid flowing through a production line. The amplitude of a NMR signal corresponding to a certain component is obtained by means of a sequence of adequate radio-frequency pulses at the relative relaxation times between the fluid components. This document does not disclose any method for the measurement of the flow-rate of a multi-component complex fluid component which signal has been separated. That is to say, it requires another device in order to measure the flow-rate of said component.

U.S. Pat. Nos. 6,046,587 and 6,268,727 disclose a sensor which uses at least two NMR spectrometers, or one NMR and another of electronic para-magnetic resonance (EPR). The basic principle of the measuring technology is based on what is known as Atime of flight@ between both spectrometers. The implementation of the set of two spectrometers which measure the residence time of each phase separately at the magnetic field is impractical and costly. Its application at oil fields, which suffer rigorous climatic conditions generally, is difficult. An obvious extension of this patent is a single spectrometer with two coils, L₁ and L₂, inserted at two positions along the production line, which two cools may be at the same time radio-frequency emitters and receivers of the respective signals, or a first emitter/receiver and a second one which only receives the passage of previously excited nuclei. Both coils may be located at a single magnet.

U.S. Pat. No. 6,452,390 discloses a method and device which implementation is simpler than the previous ones. The method employs magnetic field gradients pulsed in order to modulate the precession phase of the resonant nuclei. That is to say, the space coding is done in what is known as Alaboratory system@. The drawback of this method is that at the rate in which resonant nuclei are typically displaced on the magnetic field, it is required the application of pulsed magnetic field gradients which are relatively high, which fact represents a difficult technological implementation, as in order to produce adequate field gradients it is necessary to include important currents which on/off times are generally long. In other words, this technology is generally restricted to relatively small flow-rates measurements.

### SUMMARY

The above drawbacks and difficulties are solved by this invention, as the inventive method and device allow real time measurements of proportions and flow-rates of the different components conforming a multi-component complex fluid in a non-invasive, non-destructive way, i.e., for example, regardless of the fact of it being formed by oil and water in separate phases or as an emulsion.

It is to borne in mind that this invention can also be applied to other technological fields such as, for example, that of the dairy industry, for the determination of the milk-yogurt ratio, food and extruded organic materials, etc.

More specifically, this invention is related to a method and device for the real time direct determination of the proportions and flow-rates of the different components of a complex fluid.

Measurement of the proportions of each component of the complex fluid is carried out by means of a selection method based on the relaxation times to be detailed below.

Measurement of the different components of a complex fluid is performed by means of the application of radio-frequency pulses along with the application of an external magnetic field B₀ associated to a small gradient G, which may be linear and pulsed or linear and static, in the direction of the multi-component complex fluid flow. In the later case, said small gradient G allows the spatial coding, in the flow direction, of each set of nuclear spins of a certain component of the fluid which equal precession or Larmor frequency (hereinafter Aisochromates@).

Said spatial coding requires the use of free precession pulse sequences known as steady state free precession which shall be termed hereinafter SSFP, and continuous wave free precession (hereinafter CWFP). These pulse sequences are applied according to the fluid velocity. On the other hand, both pulse sequences may be selected by means of software, thus allowing the necessary flexibility for different flow conditions measurements.

The small gradient G associated to the external magnetic field B₀ in the flow direction of a multi-component complex fluid is attained by means of a magnet, which may be permanent or an electromagnet. More specifically, such magnet preferably consists of parallel plates wherein the distance between same increases or decreases, regardless of the complex fluid flow direction, in order to generate said gradient G.

The SSFP sequence, in its simpler version, consists of the application, to a spins set to a fluid, of a radio-frequency pulses train equally spaced with period Tₚ in the condition proximate to the resonance yB₀/2n thereof; B₀ being said external magnetic field and the gyro-magnetic ratio of nuclei (hydrogen in this case) (H. Y. Carr, Phys. Rev., 112, 1693 (1958)). Where Tₚ is established shorter than the spin-spin relaxation time T₂, there will be observed two types of steady signals in intervals anterior and posterior to each radio-frequency pulse. Analytical expressions describing the formation of the steady signal upon the lack of flow were described by R. Freeman and H. D. W. Hill, J. Magn. Reson., 4,366 (1971) and W. S. Hinsaw, J. Appl. Phys., 47, 3709 (1976). In both cases it is demonstrated that the steady signal depends from T₂, T₁, nutation angle a and separation of the resonance frequency Δω₀, and Tₚ. For a given isochromate belonging to a fluid displacing at v velocity in the application direction of a field gradient G, the precession angle a during the interval Tₚ is no longer constant but increases at an angle φ=yGvTₚ², in a cumulative manner for each interval. Consequently, the traslational temporal invariance is lost and the steady state rapidly decreases. In the actual case of a large set of isochromates, it has been shown that in the case of uniformly distributed phases (upon the action of the small gradient of linear field G), the average magnetization in that set reaches a steady state which is proportional to the fluid flow-rate (H. Gudbjartsson and S. Patz, Magn. Reson. Med., 34, 567 (1995)). These authors further demonstrated that the SSFP sequence functions in a safe manner when the T₂/Tₚ<2 relationship is established. This fact restricts the utilization of the SSFP sequence to measurements of fluid flow-rates which circulation is relatively slow.

The CWFP sequence allows measurements to be taken under higher speed fluids. Essentially, it is similar to the SSFP sequence but it characterizes in that the steady regime is reached even for values of T₂/Tₚ of up to 10⁴. In other words, extending the applicability of the flow-meter to faster fluids, M: Engelsberg (see R. B. V. Azeredo, L. A. Colnago and M. Engelsberg, Anal. Chem. 72,2401 (2000)) has studied the application of the CWFP sequence to multi-component systems, such as the measurement of the oil quantity in sunflower seeds. Authors of the same group (R. B. V. Azeredo, M. Engelsberg and L. A. Colnago, Phys. Rev. E, 64, 16309 (2001), in a later work, perform a theoretical and experimental analysis on the sensitivity of the flow technique for a mono-component system, and on the conditions under which a coherent regime is reached regarding the signal between the radio-frequency pulses. On the one part, they show that for Tₚ values necessary for attaining said CWFP regime, the steady signal is virtually insensitive to self-diffusion effects. On the other hand, they show that it is always reached a steady state dependent from the fluid velocity, even when the average over the isochromates phases is not enough.

However, the sensitivity to flow-rate shows peculiar interference effects which are strongly dependent from the resonance frequency off-set Δω₀ (ALarmor frequency off-set@). Accordingly, it is also proposed the implementation of a correction to such effect, in order to neutralize shifts at Δω₀ due to changes of the B₀ value due to environmental thermal changes.

On the other hand, determination of proportions of the different components which conform a multi-component complex fluid, as for instance the oil-water ratio of an oil production line, is based on two pulse sequence types which depend on the relaxation times of spin-lattice T₁ and spin-spin T₂, namely:

i) spin-echo sequence: this consists of the application of two pairs of radio-frequency pulses. Pulses of π/2 and n of each pair are separated by a τ₁ adequate for the generation of the corresponding spin echo. Each pair is in turn separated by an interval τ₂. Both intervals τ₁ and τ₂ are determined by taking into account velocity and the respective spin-lattice_{T1} and spin-spin T₂ relaxation times of each of the components of the multi-component complex fluid. Parameters are adjusted so that the amplitude of the first echo measures the totality of the resonant nuclei present in the fluid, and the amplitude of the second echo measures only that signal originated from the relaxed component (or that component which magnetization has been recovered) during τ₂. Where there are more than two components, more spin-echo pulse pairs should be included; and

ii) Saturation-recovery sequence: this is applied in those cases in which the spin-spin T₂ relaxation time values corresponding to the components to be measured are similar to their spin-lattice relaxation times T₁, i.e. when the spin echo has not been formed. The idea is similar, but the components intensity measurement is performed on the free induction decay (FID) following the end of a π/2 pulse.

A multi-component complex fluid is composed by a heterogeneous blend of more than one fluid, each exhibiting different Theological properties.

This invention is particularly related to the direct and independent measurement of different proportions (or cut) and flow-rate (or flow) of oil, water and gas at the vein or production line of oil wells. Determination of the flow-rate of oil flowing through the production line has always been of vital importance, both at the primary development and the secondary production stages. From the results of such measurement an estimate of the still available oil quantity which extraction is feasible is performed. That is to say, an estimate of what is known as the well “reserve” is carried out. Reserves are the physical asset of a crude-producing company and thence represent its stock market value. Specifically, these data allow quantification of both the well yield at the primary development stage and the success regarding the secondary operation procedures.

The various components conforming a complex fluid seldom appear in their pure state, but rather they form emulsions or heterogeneous mixtures, the proportions thereof varying with time, according to the fluid flow-rate, pressure and temperature conditions at the production line, etc. This particularity prevents the use of conventional flow-meters which can only measure total volume of a fluid.

Accordingly, it is an object of this application a device for the real time direct measuring of the proportion and flow-rate of the different components which conform a multi-component complex fluid, which comprises a set of associated control computer, derivation device and electronic measuring device, said derivation device being connected to a plurality of sensor assemblies through which said multi-component complex fluid circulates, wherein:

each of said sensor assemblies is surrounded by a shield and comprises a magnetic assembly;

said derivation device comprises an electronic switch;

said measuring electronic device comprises a transmitter Tx, a receiver Rx; and

said control computer is connected to said transmitter Tx, to said receiver Rx, to said derivation device, and to different information outlets.

Still another object of the present invention is a method for the direct and real time measuring of proportion and flow-rate of the different components conforming a multi-component complex fluid, which uses the above device, said method comprising the following steps:

selection of a certain sensor assembly by means of an order by said control computer to said derivation device via the electronic measuring device;

transmissions of radio-frequency pulses by means of a transmitter Tx included in said electronic measuring device, via said derivation device to said selected sensor assembly;

emission of said radio-frequency pulses from said sensor assembly in order to excite said resonant nuclei of said complex fluid generating a nuclear magnetic resonance signal (NRM) in response to said emitted radio-frequency pulses;

in combination with said radio-frequency pulses, submission of said multi-component complex fluid to a magnetic field B₀ associated to a small gradient G in the flow direction, in order to spatially code nuclear spins of said multi-component complex fluid;

reception of the response signals in said sensor assembly;

sending of said signals in said sensor assembly, via said derivation device, to a receiver Rx included in said electronic measuring device;

digitalization of said response signals received in a analog/digital converter;

sending of said digitalized signals to said control computer; and

obtention of the proportion and flow-rate of the selected component of the complex fluid by means of adequate mathematical calculations.

Still another object is a method for the real time direct measurement of the proportion and flow-rate of the different components conforming a multi-component complex fluid, which employs the above device, said method comprising the following steps:

selection of a certain sensor assembly by means of an order by said control computer to said derivation device via the electronic measuring device;

submission of said multi-component complex fluid to a pre-polarization magnetic field, in order to pre-polarize resonant nuclei of said multi-component complex fluid during a period equal to five times the spin-lattice longest relaxation time T₁ of the selected component in order to establish the proportion thereof;

transmission of radio-frequency pulses through a transmitter Rx included in said electronic measurement device, via said derivation device, to said selected sensor assembly;

emission of said radio-frequency pulses from said sensor assembly in order to excite said resonant nuclei of said complex fluid and generation of a nuclear magnetic resonance (NMR) signal in response to said emitted radio-frequency pulses;

in combination with said radio-frequency pulses, submission of said multi-component complex fluid to a magnetic field B₀ associated to a small gradient G in the flow direction, in order to spatially code nuclear spins of said multi-component complex fluid;

reception of the response signals in said sensor assembly;

sending of said signals in said sensor assembly, via said derivation device, to a receiver Rx included in said electronic measuring device;

digitalization of said response signals received in a analog/digital converter;

sending of said digitalized signals to said control computer; and

obtention of the proportion and flow-rate of the selected component of the complex fluid by means of adequate mathematical calculations.

Still another object is an arrangement of multi-component complex fluids production lines which employs the above device, wherein each of the multi-component complex fluids production lines bears fixedly attached one of said sensor assemblies; or a single sensor assembly fixedly attached on an auxiliary production line unto which the various complex fluid production lines converge. Still another object is the measuring method associated to said assembly of production lines.

Further, one of the objectives of this invention is the determination of the flow-rate of the selected component by means of the NMR signal evolution measurement upon the ending of the first radio-frequency pulses at the SSFP or CWFP sequences, from the steady signal which is generated once the steady regime is attained.

Still another object is that the alternancy between the SSFP-CWFP pulses sequences in order to determinate the flow-rate of the selected component according to the fluid velocity be performed with the same device by means of an adequate software.

Still another object is that the Asaturation-recovery@ and Aspin-echo@ sequences be used alternatively and with the same device in order to determine the proportion of the selected component from the multi-component complex fluid.

Still another object is that the NMR signal may be obtained by means of the resonant excitation and off resonance detection, termed ATONROF@.

Still another object is that the sensitivity to flow-rate measurement does not show peculiar interference effects, by means of the neutralization of eventual shifts at Δω₀, due to changes of the B₀ value by virtue of environmental thermal changes.

Still another object is that different production lines through which a multi-component complex fluid flows have different sensor assemblies mounted, or that all of the production lines converge unto a single production line bearing a single sensor assembly.

Still another object is that said sensor assemblies are fixed or movable.

### BRIEF DESCRIPTION OF THE DRAWINGS

The invention shall be best understood when read in conjunction with the following figures:

FIG. 1 shows a schematic view of the device according to the invention.

FIG. 2a shows a block diagram of the electronics associated to the device according to the invention.

FIG. 2b is a schematic view of a sensor device included in the device according to the invention.

FIG. 2c is a schematic view of the derivation device of the device according to the invention.

FIG. 3a illustrates the two pulses sequences used for the determination of the proportion of a component of a multi-component complex fluid.

FIG. 3b illustrates the signal obtained by means of the application of the pulses sequences for the determination of the flow-rate of a multi-component complex fluid.

### DETAILED DESCRIPTION OF THE PREFERRED EMBODIMENTS

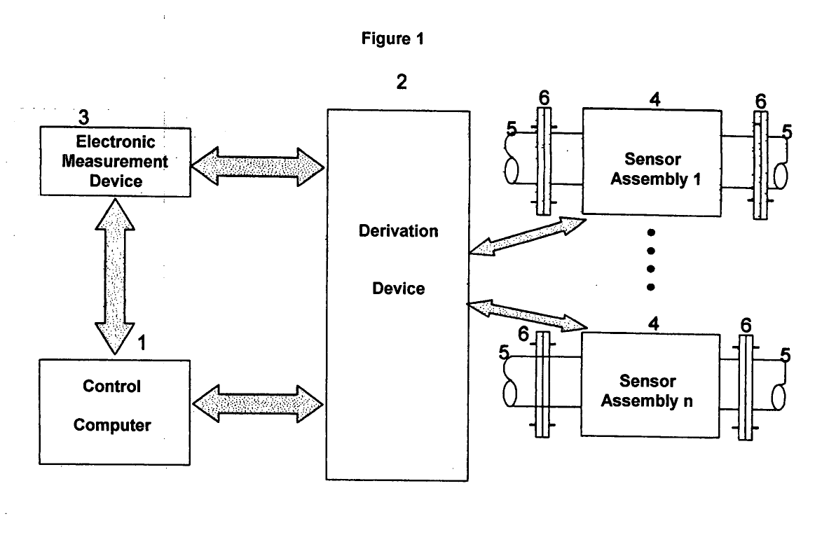

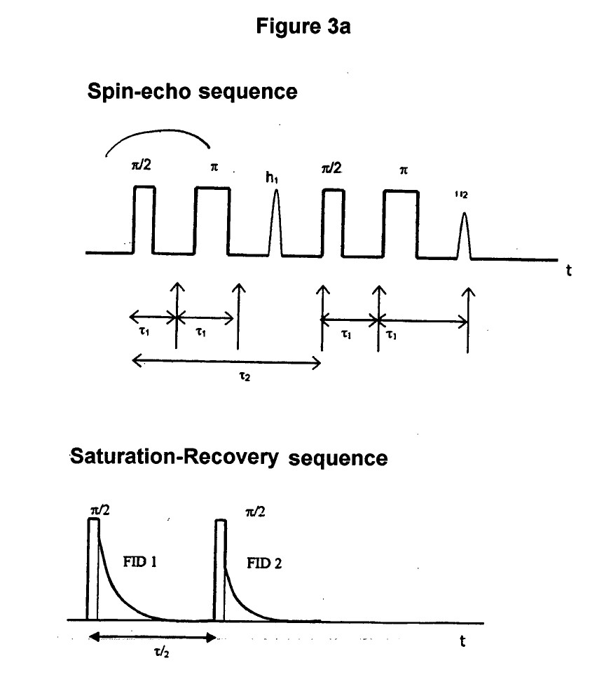

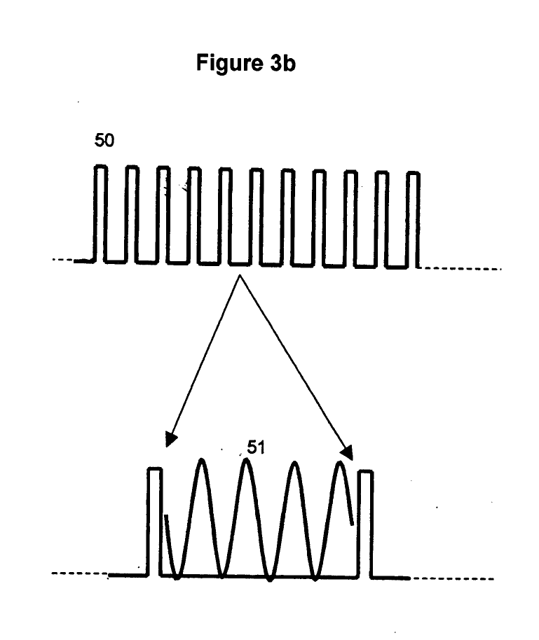

FIG. 1 illustrates control computer 1, associated derivation device 2 and associated electronic measurement device 3. In turn said derivation device 2 is connected to a plurality of sensor assemblies 4, each of them mounted on a production line 5. Control computer 1 sends a command to derivation device 2 in order to select a certain sensor assembly 4 by means of the electronic measuring device 3. Once the selection operation is done, computer 1 orders the electronic measuring device 3 to trigger the sequence for the measurement of components proportion. To such effect a sequence of spin-echo or saturation-recovery is used, as may correspond. Once this measurement step is finished, the determination of the flow-rate of the component selected from the multi-component complex fluid proceeds, by means of the application of an SSFP or CWFP sequence (which shall be explained below with the aid of FIGS. 3b and 3c).

Each sensor assembly 4 may be mounted on a production line 5 by means of flanges 6, or may be movable as will be described below.

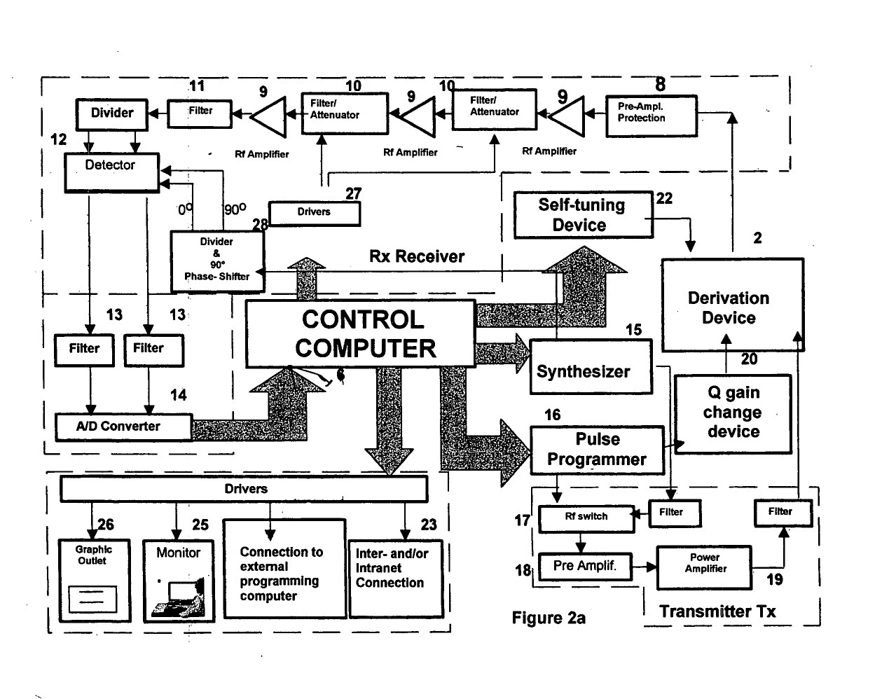

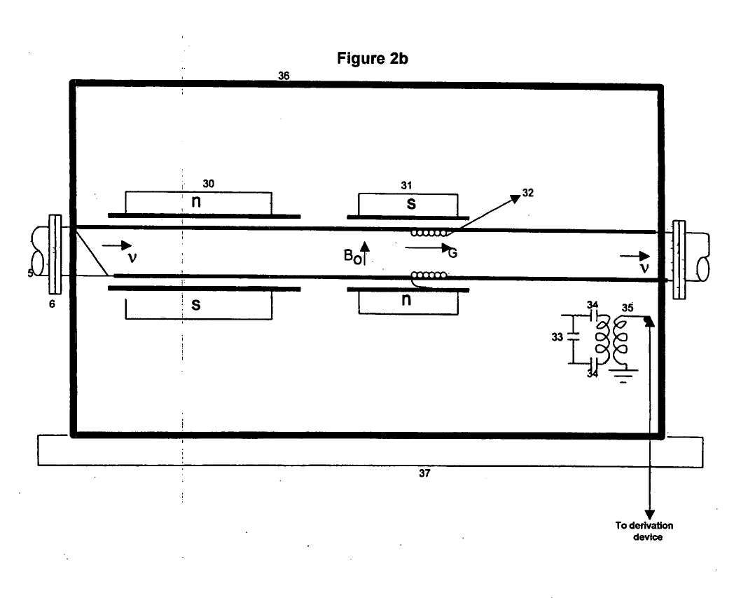

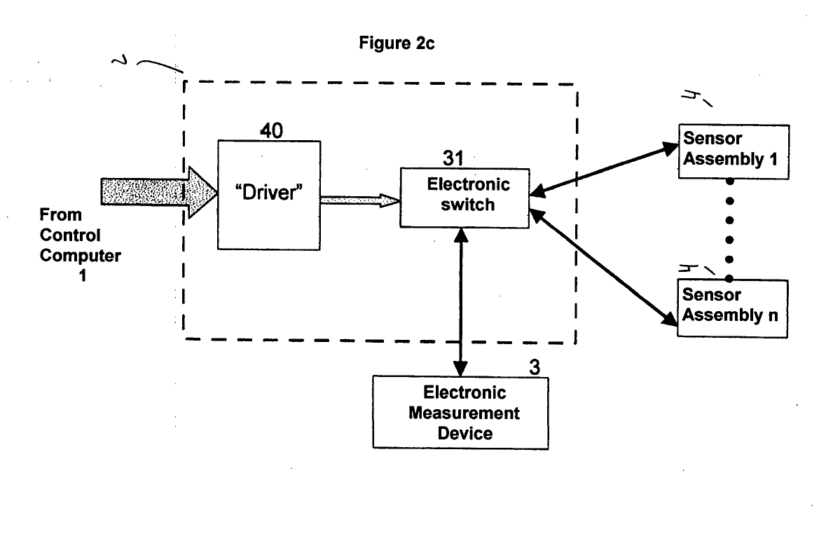

FIG. 2a is a detailed illustration of the electronic measuring device 3. The signal exciting resonant nuclei of the complex fluid is generated at a transmitter Tx and is transmitted to a sensor assembly 4 through said derivation device 2. Within said sensor assembly 4 (see FIG. 2b) an NMR signal is generated, which is then transmitted to a receiver Rx. Said receiver Rx comprises a protection step 8 at the inlet thereof, followed by radio-frequency amplifiers 9 which amplify said NMR signal in several steps. Said signal is in turn filtered at filters 10 and 11. Then, the amplified NMR signal passes through a divider and enters a detector which is sensitive to phase 12, which along with a divider and phase-shifter 28 forms the quadrature detector of a spectrometer. Finally, the analog signal is converted into a digital one at an A/D converter 14, after being filtered once more by filters 13. Digital signal is introduced into the control computer 1 to be analyzed. Amplifiers gain of receiver Rx is controlled by the computer through drivers 27, in order to adequate same to the mass range of each component of the multi-component complex fluid to be detected.

More particularly, the excitation signal is generated from a radio-frequency signal originated from a synthesizer 15, preferably a direct digital synthesizer (DDS) which is controlled by the control computer 1, and from the digital pulses generated from a pulse programmer 16, also controlled by computer 1. Both signals enter radio-frequency switch 17, conforming a signal which is amplified at a pre-amplifier 18 and subsequently at a power amplifier 19, thus generating radio-frequency pulses of an adequate power (typically 200 W), which pulses excite resonant nuclei of the multi-component complex fluid selected component at the sensor assembly 4. Said pulse programmer 16 also controls a gain change device Q 20. In this way, spectrometer idle time is substantially decreased, the signal-to-noise ratio increases and thence, the minimum detection threshold decreases. This idle time is defined as that occurring immediately after the radio-frequency pulse is off, and thus there remains stored power at detector assembly 4. Said power overlays the very weak signal from the multi-component complex fluid nuclei, thus producing a shield effect over said NMR signal. Gain Q change of the sensor assembly 4 circuit allows a quick relaxation of power stored therein, thus enabling the detection of said signal nearer the end of said radio-frequency pulse. This improvement allows decreasing of the intervals existing between radio-frequency pulses T_{d}, and thence flow-rate measurement range may be increased.

As a consequence of eventual measurement variations due to thermal effects (as will be described bellow), a self-tuning device 22 is included which is commanded by control computer 1 and is connected to said sensor assembly 4.

Finally, control computer 1 commands the different information outlets, as for instance to an Inter- and Intranet connection 23, an external programming computer 24, a monitor 25 and/or a graphic outlet 26.

FIG. 2b illustrates a preferred example of a sensor assembly 4 fixedly mounted on a production line. Said assembly comprises a magnetic set consisting of two mutually adjacent magnets 30,31, which generate two magnetic fields, namely:

i) a first pre-polarization magnetic field generated from said first magnet 30 located at the end of sensor assembly 4 through which complex fluid enters and which objective is to pre-polarize the multi-component complex fluid during a time estimated as five times the value of the spin-lattice longer relaxation time T₁ of the component which proportion is required; and

ii) a second magnetic field B₀ associated to a small linear gradient G, preferably linear and preferably pulsed or static as regards flow direction, which velocity is v.

The reason for the inclusion of the first magnet 30 is that usually the multi-component complex fluid velocity which passes through a sensor assembly 4 is high, whereby said second magnetic field B₀ itself is not sufficiently effective for the resonant nuclei of said complex fluid to attain the maximum polarization.

However, there exist situations wherein the velocity of the complex fluid circulating through said sensor assembly 4 fixedly mounted on production line 5 is low; or sensor assembly 5 is movable, the displacement velocity thereof being adjustable as regards the complex fluid. In such cases, it will be required a magnetic set including only a single magnet 31, which may be fixed or movable, and which shall be associated to said coupling circuit. It is thence clear that the inclusion of a pre-polarization magnetic field depends from the relative velocity existing between said sensor assembly 4 and said complex fluid.

Referring again to the above example, second magnetic field B₀ is generated with said second magnet 31, which may be a permanent magnet or an electromagnet, and possesses an adequate geometry able to generate small gradient G in the direction of flow of the complex fluid. Design thereof is within the understanding of the average person skilled in the art, but preferably it consists of parallel plates which are positioned totally opposed to said production line 5, wherein distance between them increases in the flow direction in order to generate said gradient G. Said second magnetic field B₀ is used for the spatial localization of the multi-component complex fluid component which flow-rate is to be measured.

Said second magnet 31 is associated to a coil 32 which emits and receives above mentioned radio-frequency pulses. Said coil 32 generates a linearly polarized oscillating magnetic field which excites resonant nuclei of the complex fluid and also acts as an antenna which receives the NMR signal. Said coil 32 should be located as regards said second magnet 31 in such a way that it remains immersed within the magnetic field B₀ generated by it. Coil 32 is tuned by means of tuning capacitor 33 and adapts its impedance through capacitors 34. Coupling circuit is completed with a balanced/non-balanced transformer or ABALUM@ 35 which adapts the balanced mode of the circuit conformed by coil and capacitors 32, 33 and 34, to a convenient non-balanced outlet in order to couple to said derivation device 2. All of the sensor assembly 4 is surrounded by a shield 36 and supported by a base 37. Said shield 36 performs several functions, namely:

i) isolation of said sensor assembly from external noise and sharp temperature changes;

ii) protection of said sensor assembly 4 from field blows; and

iii) prevention of spills of the multi-component complex fluid upon accidents or breakage at the internal part of said sensor assembly 4.

Said coil 32 geometry may be solenoidal or bird-cage type.

FIG. 2c illustrates a schematic of derivation device 2. Said derivation device comprises an electronic switch 31, preferably a coaxial switch, which is commanded by control computer 1 by means of driver 40. Function of said derivation device 2 is to select sensor assembly 4, coupling radio-frequency exchange between selected sensor assembly 4 and electronic measurement device 3.

FIG. 3a shows two schematics illustrating the two radio-frequency sequences used for the determination of the proportions of the multi-component complex fluid components, particularly oil and water, already described: a spin-echo sequence and a saturation-recovery sequence. These two components of said complex fluid may be distinguished by their respective relaxation times T₁ and T₂. There follows a detailed description of the obtention manner of the signals which allow determination of the proportions of said components, as a response to said pulses sequences.

i) Spin-echo sequence: a train of radio-frequency pulses in resonance condition is applied to the resonant nuclei of the complex fluid. The first pulse produces rotation of nuclear magnetization (or polarization) at an angle of 90□ with respect to the axis on which said magnetic field B₀ is applied (named π/2 pulse). The second pulse, which intensity duplicates that of the first one and is called π pulse, is applied a time τ₁ which is very short as compared to the shorter spin-lattice relaxation time T₁ of the complex fluid components. This produces the formation of an NMR signal after the second pulse. This signal is termed spin echo, or simply echo. The amplitude of the echo signal, named h₁, is directly proportional to the totality of resonant nuclei which compose the complex fluid. By applying a second pulses train which radio-frequency is similar to that of said first pulse train and during a time τ₂ after the echo, a second echo is obtained, at a time of 2 τ₂ from the start of said second pulse train, which amplitude h₂ is directly proportional only to the quantity of fluid component exhibiting the shorter spin-lattice relaxation time T₁. In this embodiment, amplitude h₂ is proportional to the oil quantity, as T₁ₒᵢₗ<T_{1water}. In the case of a complex fluid bearing more than two components, there are used as many pulse radio-frequency pairs as measurable components proportions exist. By means of a digitalization process of all of the sequence response signals and the application of a simple mathematics, the proportion of both components of the complex fluid, oil and water, is obtained. There follows a detail of extreme cases of water only and oil only:

where h₁ equals h₂, there will only be oil in the sensor assembly 4;

where h₂=0, there will only be water in the sensor assembly 4, as for the second reading sequence, all of the resonant nuclei of water will not be recovered (they remain saturated) and consequently, h₁ measure will be proportional to the water quantity in the sensor assembly 4.

ii) Saturation-recovery sequence: two radio-frequency π/2 pulses are applied, separated by a time τ₂. Amplitudes h₁ and h₂ are measured, respectively, on the free induction decay (FID) signals at the end of each π/2 pulses. h₁ and h₂ meanings are the same as for the spin-echo sequence.1 Saturation-recovery pulses sequence is used for those cases in which the complex fluid components exhibit a spin-lattice relaxation time T₁ approaching the spin-spin relaxation time T₂.

FIG. 3b illustrates a pulse sequence 50 which is preferred for the measurement of multi-component complex fluid components selected, namely: the continuous wave free precession or CWFP sequence. The amplitude of the obtained stationary oscillatory steady signal 51 linearly depends from the fluid velocity, within the range of flow-rates to be measured for each particular application.

In all of the above expressed pulse sequences it is possible to change the reference sequence during the stage of spin echo signal detection. This operation is accomplished by means of a change of the frequency of synthesizer 15, preferably a direct digital synthesizer (DDS), and it is enabled by a pulse originated from pulse programmer 16. It is worth noting that said change, in the case of our circuit, takes place in a few nanoseconds. In the quadrature detection stage a signal Abeating@ is attained, both of the FID and the spin echo, which is in synchrony with the moment when said signal is digitalized at the respective stage. In this way it is possible to increase the frequence content of the echo and/or FID by Δv=v₀-v_{ref}, i.e. equal to the difference between the nuclear precession frequency (which is equal to that of irradiation at the condition of exact resonance) and the frequency at the detection time. This allows, at the frequencies spectrum, a displacement of the echo signal which is received at the resonance condition adding a frequency content to it. In effect, at the resonance condition (and also at the resonance irradiation one) the echo obtained at the end of the detection stage which is sensitive to phase and in quadrature, only possesses components of very low frequency. Now, when reference frequency is changed by a known amount, it is attained the condition known as Abeat echo@, which exhibits a frequency content which can be externally controlled; it being usually comprised on the range of tenths and even hundredths of kHz. As the signal-to-noise ratio (SNR) increases with the echo prevailing content of frequencies, via the displacement of the reference signal frequency at the quadrature detector it is possible to digitalize a signal with a noticeable improvement of the signal-to-noise ratio. This innovation can be applied to all the known pulse sequences, and particularly to the above mentioned ones, and can be applied at the same time a procedure known as Aphase cycling@ is performed. This procedure is used in order to eliminate:

i) noise effects at the base line; and

ii) coherent noise signals (see E. Fukushima and S. B. W. Roeder: AExperimental Pulse RMN: A Nuts and Bolts approach@, Addison-Wesley Publishing Co., Reading, Mass., USA (1981)).

By means of the shift of the reference signal for the detection immediately after the end of the radio-frequency pulse, it is possible, for both SSFP and CWFP sequences, to irradiate spins in resonance condition and to detect the evolution off resonance also known as ATONROF@ (Transmission On Resonance-Reception Off Resonance).

Said procedure will consist of:

irradiation of the set of complex fluid resonant nuclei with an oscillatory magnetic field B₁ which is adjusted to its resonance frequency;

programming of a synthesizer frequency, preferably a direct digital synthesizer (DDS) at the condition of resonance (on resonance):

during the detection stage, changing of the frequency of said synthesizer by means of a command pulse from a pulse programmer in order to increase the signal-to-noise ratio; and

digitalization of the signal by means of a analog/digital converter to a fixed frequency of the order of 10 to 100 kHz, as may be more convenient.

Further, said TONROF technique may be combined with simple or complex pulses sequences, named steady and non-steady, as follows:

Said procedure of resonant excitation and off resonance detection (TONROF) may be also applied to the steady sequence of simple pulses known as steady state free precession (SSFP), which will consist of the irradiation of the sample with successive pulses of π/2 on the spins nuclei; and digitalization of the NMR signal originated therefrom at the intervals between pulses.

Also, the TONROF technique may be applied to a steady sequence of simple pulses known as continuous wave free precession (CWFP) in which the signal is excited and detected off resonance.

Lastly, it may also be applied to a non-steady sequence of pulses know as spin-lock spin echo (SLSE), which maintains the nuclear quadrupolar resonance signal (NQR) echo during an effective time T₂, longer than decay T₂ of the pulse sequence, and which will consist of:

application of a first radio-frequency pulse to the compound, which will produce said oscillatory magnetic field B₁ of a amplitude such that it will be able to re-orient magnetization of resonant nuclei of the complex fluid at an angle of 90□ and a phase of 0□ for said digital direct synthesizer (DDS);

after the elapsing of a time τ, application of a new high frequency pulse, this of a double time or able to re-orient sample 180□ and phase at 90□ as regards the previous one, at exactly a same period τ since the end of said new high frequency pulse, for the appearance of a spin echo;

repetition of the above step until n echoes are collected; digitalization and adding thereof.

Under adequate conditions the oil and water flow-rate may be directly measured from the measurement of the NMR digitalized signal evolution at the end of the first radio-frequency pulses at the SSFP sequence. The amplitude of the FID following the application of the first radio-frequency is proportional to the total number of resonant nuclei present in the fluid, whereas the signal following the next pulses, before the steady state is reached, is proportional to the resonant nuclei of the fluid component with shorter relaxation time. Thus, the selected component flow-rate is measured from the steady signal generated from said pulses sequence once said steady regime is attained. Measurements are carried out with the same device, it only being necessary to adapt the corresponding software for each measurement.

On the other hand, it has been observed that sensitivity of the technique shows interference effects strongly dependent from the off-set of the resonance frequency Δω₀ (Larmor frequency off-set). In this application it is also proposed the implementation of a correction to such effect, in order to neutralize shifts at Δω₀ due to changes of the B₀ value by environmental thermal changes, as previously mentioned, by means of the inclusion of a self-tuning device 22.

A preferred correction method is established by means of the modulation of the reference frequency during the detection periods, alternatively between radio-frequency pulses. Another correction method contemplates the inclusion of several receivers Rx, each with mutually shifted demodulation frequencies for the radio-frequencies in a convenient quantity, which may be carried out by any average person skilled in the art.

On the other hand, it is known that changes of the fluid temperature may slightly modify its rheological conditions, as well as the NMR signal intensity, for the same spin density. Consequently, it may be necessary to correct the flowmeter reading by a temperature-dependent factor. A person of average skill on the art can measure and calibrate said correction factors.

In certain applications in which the fluid contains considerable quantities of particles and/or other magnetic elements capable of obstructing the fluid passage, as well of inducing systematic reading errors, both regarding the proportions and flow-rate, it is necessary to include a temporal demagnetization device, which is within the understanding of the average person skilled in the art.

In order to compensate continuous voltage errors (offset) of the quadrature reception channels, which are generally produced by the devices of the video amplifying stages, there are carried out sequential measurements with phase differences at the reception of 0 and 180□ respectively. Similarly, in order to compensate said errors and further, the possible gain errors of said video amplifiers, there are used sequences of four or more pulses, preferably that known as Acyclop@.

Physical location of the inventive device, and more particularly of the sensor assemblies 4 conforming same, may be varied. A possible arrangement is that each of the several multi-component complex fluids production lines 5 be associated to a sensor assembly 4. In this case, the measurement method associated to said production lines arrangement is performed as follows:

sequentially, i.e. for each production line 5, by means of an adequate program; or

simultaneously, i.e. flow-rate and proportions of the complex fluid components in each production line 5 are measured at the same time and then added.

Another possible arrangement consists of a single sensor assembly 4 associated to an auxiliary production line (not shown) unto which the different production lines 5 converge. To such end, a two-way two-position valve (not shown) is installed on each of them, which valve is electronically controlled. These valves allow the sequential passage of the complex fluid of each production line 5 towards the sensor assembly 4 under the command of control computer 1. Thus, the measurement method associated to this arrangement of production lines shall be implemented line by line in an alternate way, at time intervals which shall be established as a function of the number of production lines 5 connected to the auxiliary production line.

A sensor assembly 4 may also be movable and comprise a magnetic assembly consisting of a movable magnet 31, associated to a coupling circuit conformed by a coil 32, which emits and receives radio-frequency pulses. In this case, and as previously mentioned, it will not be necessary to include a pre-polarization magnetic field, due to the fact that the displacement rate of the movable sensor assembly 4 is adjustable as per the velocity of the complex fluid to be measured. Said movable magnet 31 is axially displaceable within said movable sensor assembly 4.

In a first application, said movable sensor assembly 4 is directly introduced into tanks of multi-component complex fluids and/or into silos storing multi-component materials. More specifically, into tanks storing oil and water, or into silos storing seeds and other granular materials.

There follows the description of a preferred embodiment consisting of the application of a movable sensor assembly 4 for a three-level tank: the top level consists of an oil volume, the intermediate level bears a volume composed of an oil-water emulsion; and the bottom level bears a water volume.

As the movable sensor assembly is introduced from the top of said tank, the digitalized signal measuring the amplitudes of the nuclear magnetic resonance (NMR) signal h₁ and h₂ establishes similar values for the top volume, as it consists exclusively of oil. When the movable sensor assembly reaches the intermediate level, h₁ starts increasing, as the first echo intensity is added with the water resonant nuclei, which comparatively produce a more intense nuclear magnetic resonance (NMR) signal, and h₂ decreases because oil quantity starts decreasing. Lastly, upon reaching the bottom level, h₁ and h₂ values will be again similar, because the movable sensor assembly will only detect water.

In a second application, said movable sensor assembly 4 is introduced into a tube, preferably a plastic tube, so as to avoid contact of said movable sensor assembly 4 with an aggressive medium. In such case, the scheme is inverted, the complex fluid being outside said tube.

What is claimed is:

1. A device for the real time direct measuring of the proportion and flow-rate of the different components which conform a multi-component complex fluid, characterized in that said device comprises a set of mutually associated control computer, derivation device and electronic measuring device, said derivation device being connected to a plurality of sensor assemblies through which said multi-component complex fluid circulates, wherein:
each of said sensor assemblies is surrounded by a shield and comprises a magnetic assembly;
said derivation device comprises an electronic switch;
said measuring electronic device comprises a transmitter Tx, a receiver Rx; and
said control computer is connected to said transmitter Tx, to said receiver Rx, to said derivation device, and to different information outlets.

2. A device according to claim 1, characterized in that each of said sensor assemblies is fixedly mounted on a production line by means of flanges and is supported by a base.

3. A device according to claim 1, characterized in that said magnetic assembly consists of a magnet, preferably a permanent magnet or an electro-magnet, which is associated to a coupling circuit.

4. A device according to claim 3, characterized in that said coupling circuit is conformed by a radio-frequency pulses emitter and receiver coil, which coil is positioned in such a way that it remains immersed within the magnetic field B₀ generated by said magnet, said coil being connected in parallel to a tuning capacitor, the later being connected in parallel to a set of capacitors and to a balanced/non-balanced transformer which non-balanced outlet is connected to said derivation device.

5. A device according to claim 1, characterized in that said magnetic set is composed of:
a first magnet located at the end of said sensor assembly through which said complex fluid enters; and
a second magnet which is adjacent to said first magnet, associated to a coupling circuit.

6. A device according to claim 5, characterized in that said first magnet is a permanent magnet which generates a pre-polarization magnetic field.

7. A device according to claim 5, characterized in that said coupling circuit consists of a radio-frequency pulses emitter and receiver coil, which coil is positioned in such a way that it remains immersed within the magnetic field B₀ generated by said second magnet, said coil being connected in parallel to a tuning capacitor the later being connected in parallel to a set of capacitors and to a balanced/non-balanced transformer which non-balanced outlet is connected to said derivation device.

8. A device according to claim 1, characterized in that each of said sensor assemblies is movable.

9. A device according to claim 8, characterized in that said movable sensor assembly is directly introduced into the complex fluid.

10. A device according to claim 8, characterized in that said movable sensor assembly is introduced into a tube, preferably a plastic tube.

11. A device according to claims 1, characterized in that the magnetic set of each of said movable sensor assemblies is composed of a movable magnet, associated to a coupling circuit.

12. Device according to claim 11, characterized in that movable magnet is preferably a permanent magnet or an electromagnet, which is axially displaceable within said movable sensor assembly.

13. A device according to claim 11, characterized in that said coupling circuit is formed by a radio-frequency pulses emitter and receiver coil, which is connected in parallel to a tuning capacitor, the later being connected in parallel to a set of capacitors and to a balanced/non-balanced transformer, the outlet of which is connected to said derivation device.

14. A device according to claim 1, characterized in that said transmitter Tx comprises a radio-frequency switch which inlet is connected to a synthesizer which generates a radio-frequency signal and a pulse programmer which generates digital pulses, both commanded by control computer; and which outlet is connected to a pre-amplifier in turn connected to a power amplifier, there being accordingly generated radio-frequency pulses of adequate power in order to excite resonant nuclei of the multi-component complex fluid selected component which circulates in a sensor assembly.

15. A device according to claim 14, characterized in that said synthesizer is a direct digital synthesizer (DDS).

16. A device according to claim 1, characterized in that said receiver RX comprises a protection stage at the inlet thereof connected to radio-frequency amplifiers which amplify the signal received from each of said plurality of sensor assemblies, said signal being previously filtered by filters, the last of said radio-frequency amplifiers being connected to a detector which in combination with a divider and a phase-shifter forms a quadrature detector; said detector is then connected to filters which outlets are connected to an analog-digital converter which is connected to said control computer.

17. A device according to claim 16, characterized in that said detector is a phase-sensitive detector.

18. A device according to claim 16, characterized in that said radio-frequency amplifiers gain is commanded by control computer by means of drivers.

19. A device according to claim 14, characterized in that said pulse programmer is connected to a gain Q change device in order to substantially reduce idle time of the spectrometer, the signal-to-noise being increased and accordingly the minimum detection threshold is decreased.

20. Device according to claim 1, characterized in that said electronic measurement device further includes a self-tuning device which inlet is connected to said control computer (1) and its outlet to each sensor assembly.

21. Device according to claim 1, characterized in that said information outlets consist of an Inter- and Intranet connection, an external programming computer, a monitor and/or graphic outlet.

22. Device according to claim 4, characterized in that said coil exhibits a solenoidal or bird-cage configuration.

23. Device according to claim 1, characterized in that it also optionally includes a temporal demagnetization device.

24. Device according to claim 1, characterized in that said electronic switch is preferably a coaxial switch commanded by said control computer by means of controller.

25. A method for the real time direct measurement of the proportion and flow-rate of the different components which conform a multicomponent complex fluid, which uses the device according to claim 1, characterized in that, when the relative velocity between the complex fluid and the sensor assembly through which it circulates is low, said method comprises the following stages:
selection of a certain sensor assembly by means of an order by said control computer to said derivation device via the electronic measuring device;
transmissions of radio-frequency pulses by means of a transmitter Tx included in said electronic measuring device, via said derivation device to said selected sensor assembly;
emission of said radio-frequency pulses from said sensor assembly (4) in order to excite said resonant nuclei of said complex fluid generating a nuclear magnetic resonance signal (NRM) in response to said emitted radio-frequency pulses;
in combination with said radio-frequency pulses, submission of said multi-component complex fluid to a magnetic field B. associated to a small gradient G in the flow direction, in order to spatially code nuclear spins of said multi-component complex fluid;
reception of the response signals in said sensor assembly;
sending of said signals in said sensor assembly, via said derivation device, to a receiver Rx included in said electronic measuring device;
digitalization of said response signals received in a analog/digital converter;
sending of said digitalized signals to said control computer; and
obtention of the proportion and flow-rate of the selected component of the complex fluid by means of adequate mathematical calculations.

26. A method for the real time direct measurement of the proportion and flow-rate of the different components which conform a multicomponent complex fluid, which uses the device according to claim 1, characterized in that, when the relative velocity between the complex fluid and the sensor assembly through which it circulates is low, said method comprises the following stages:
selection of a certain sensor assembly by means of an order by said control computer to said derivation device via the electronic measuring device;
submission of said multi-component complex fluid to a pre-polarization magnetic field, in order to pre-polarize resonant nuclei of said multi-component complex fluid during a period equal to five times the spin-lattice longest relaxation time T₁ of the selected component in order to establish the proportion thereof;
transmission of radio-frequency pulses through a transmitter Rx included in said electronic measurement device, via said derivation device, to said selected sensor assembly;
emission of said radio-frequency pulses from said sensor assembly in order to excite said resonant nuclei of said complex fluid and generation of a nuclear magnetic resonance (NMR) signal in response to said emitted radio-frequency pulses;
in combination with said radio-frequency pulses, submission of said multi-component complex fluid to a magnetic field B₀ associated to a small gradient G in the flow direction, in order to spatially code nuclear spins of said multi-component complex fluid;
reception of the response signals in said sensor assembly;
sending of said signals in said sensor assembly, via said derivation device, to a receiver Rx included in said electronic measuring device;
digitalization of said response signals received in a analog/digital converter;
sending of said digitalized signals to said control compute; and
obtention of the proportion and flow-rate of the selected component of the complex fluid by means of adequate mathematical calculations.

27. Method according to claim 25, characterized in that said gradient G is preferably linear and pulsed.

28. Method according to claim 25, characterized in that said gradient G is preferably linear and steady.

29. Method according to claims 25, characterized in that said radio-frequency pulses conform a spin-echo sequence or a saturation-recovery sequence in order to establish the proportion of the selected component.

30. Method according to claim 29, characterized in that the spin-echo sequence consists of:
application of a radio-frequency pulse train on resonance condition to the resonant nuclei of said complex fluid;
rotation, by means a first pulse, named π/2 pulse, of nuclear magnetization at an angle of 90° with respect to the axis on which said magnetic field B₀ is applied;
application of a second pulse, which intensity duplicates that of the first one and is called π pulse, during a time u which is very short as compared to the shorter spin-lattice relaxation time T₁ of the complex fluid components;
obtention of a nuclear magnetic resonance signal (NMR) after said second pulse, named spin echo or simply echo, which amplitude h₁ is directly proportional to the totality of resonant nuclei which compose the complex fluid;
application of a second radio-frequency pulses train similar to that of said first pulse train and during a time τ₂ after said echo is obtained;
obtention of a second nuclear magnetic resonance (NMR) signal, or second echo, at a time of 2 τ₁ from the start of said second pulse train, which amplitude h₂ is directly proportional only to the quantity of fluid component exhibiting the shorter spin-lattice relaxation time T₁;
digitalization of all of such sequence response signals; and
obtention of the selected components proportion by means of adequate mathematical calculations.

31. Method according to claim 29, characterized in that the saturation-recovery sequence consists of:
application of two radio-frequency pulses of π/2, separated by a τ₂; and
measurement of amplitudes h₁ and h₂, respectively, on the free induction decay (FID) signals at the end of each π/2 pulses.

32. Method according to claim 31, characterized in that the saturation-recovery pulses sequence is used in those cases in which the complex fluid components exhibit a spin-lattice relaxation time T₁ approaching the spin-spin relaxation time T₂, i.e. when the spin echo has not been formed, the components intensity measurement being performed on the free induction decay (FID) following the end of a π/2 pulse.

33. Method according to claim 25, characterized in that said radio-frequency pulses conform a continuous wave free precession (CWFP) or a steady state free precession (SSFP) one in order to establish the flow-rate of the selected component from the measurement of the evolution of said nuclear magnetic resonance (NMR) signal.

34. Method according to claim 33, characterized in that said steady state free precession (SSFP) sequence consists of the application to a spins set of a fluid of a radio-frequency pulses train equally spaced with period Tₚ in the condition proximate to the resonance yB₀/2n thereof; B₀ being said external magnetic field and y the gyro-magnetic ratio of nuclei.

35. Method according to claim 33, characterized in that the continuous wave free precession (CWFP) sequence is similar to the SSFP sequence but the steady regime is reached even for values of T₂/Tₚ of up to 10⁴, thus being applied to faster fluids.

36. Method according to claim 25, characterized in that in the case of a complex fluid with more than two components there are used as many pulse radio-frequency pairs as components proportions one desires to measure.

37. Method according to claim 33, characterized in that in all of the free precession sequences it is possible to change the reference sequence during the detection of the spin echo signal.

38. Method according to claim 37, characterized in that said change is carried out by means of a change of the frequency of synthesizer (15), preferably a direct digital synthesizer (DDS) and is enabled by pulse originated from pulse programmer 16; thus, during the detection quadrature step a signal Abeating@ is attained, both of the free induction decay (FID) and the spin echo, which is in synchrony with the moment when said signal is digitalized at the respective stage; it is thus possible to increase the frequence content of the echo and/or free induction decay (FID) by: Δv=v₀-v_{ref}, i.e. equal to the difference between the nuclear precession frequency and the reference frequency at the detection time.

39. Method according to claim 37, characterized in that said change of the reference frequency allows irradiation of spins at the resonance condition and detection of the evolution off resonance (TONROF).

40. Method according to claim 39, characterized in that said detection at the off resonance conditions consists of:
irradiation of the set of complex fluid resonant nuclei with an oscillatory magnetic field B₁ which is adjusted to its resonance frequency;
programming of a synthesizer frequency, preferably a direct digital synthesizer (DDS) at the condition of resonance (on resonance):
during the detection stage, changing of the frequency of said synthesizer (15) by means of a command pulse from a pulse programmer in order to increase the signal-to-noise ratio; and
digitalization of the signal by means of the analog/digital converter (14) to a fixed frequency of the order of 10 to 100 kHz, as may be more convenient.

41. Method according to claim 40, characterized in that said procedure of resonant excitation and off resonance (TONROF) detection is combined with simple or complex pulses sequences, denominated steady and non-steady.

42. Method according to claim 41, characterized in that said procedure of resonant excitation and detection off resonance (TONROF) may be also applied to the steady state free precession (SSFP), which will consist of the irradiation of the sample with successive pulses of π/2 on the spins nuclei; and digitalizing of the NMR signal originated therefrom at the intervals between pulses.

43. Method according to claim 41, characterized in that said procedure of resonant excitation and detection off resonance (TONROF) may be also applied to a continuous wave free precession sequence (CWFP), in which the resulting signal is excited and detected off resonance.

44. Method according to claim 41, characterized in that said procedure of resonant excitation and detection off resonance (TONROF) may be also applied to a non-steady pulses sequence denominated spin lock spin echo (SLSE) which maintains the nuclear quadrupolar resonance (NQR) echo during an effective time T₂, longer than decay T₂ of the pulse sequence, and which will consist of:
application of a first radio-frequency pulse to the compound, which will produce said oscillatory magnetic field B₁ of a amplitude such that it will be able to re-orient magnetization of resonant nuclei of the complex fluid at an angle of 90° and a phase of 0° for said synthesizer (15);
after the elapsing of a time τ, application of a new high frequency pulse, this of a double time or able to re-orient sample 180° and phase at 90° as regards the previous one, at exactly a same period τ since the end of said new high frequency pulse, for the appearance of a spin echo;
repetition of the above step until n echoes are collected; digitalization and adding thereof.

45. Method according to claim 25, characterized in that in order to compensate for continuous voltage errors (offset) of the quadrature reception channels, which are generally produced by the devices of the video amplifying stages, there are carried out sequential measurements with phase differences at the reception of 0° and 180° respectively.

46. Method according to claim 45, characterized in that in order to compensate for continuous voltage errors (offset) and the possible gain errors in such video amplifiers, there are used sequences of four or more pulses, preferably that known as “cyclop”.

47. Method according to claim 25, characterized in that shifts at the resonance frequency Δω₀ due to changes of the magnetic field B₀ value due to environmental thermal changes are neutralized by means of the reference frequency modulation during the detection periods, alternatively between radio-frequency pulses; or by means of the inclusion of several receivers Rx, each with demodulation frequencies of radio-frequencies mutually shifted in a convenient quantity.

48. Method according to claim 25, characterized in that changes in the fluid temperature and changes of the NMR signal intensity are corrected by means of a correction of the reading thereof by a factor which is temperature-dependent.

49. Method according to claims 25, characterized in that when the fluid contains considerable quantities of particles and/or other magnetic elements capable of obstructing the fluid passage and inducing systematic reading errors, both regarding the proportions and flow-rate, it is necessary to include a temporal demagnetization device.

50. An arrangement of production lines for a multi-component complex fluid which uses the device according to one 1, characterized in that each of the various production lines of multi-component complex fluids is associated to one of said sensor assemblies.

51. A method for the real time and direct measurement the proportion and flow-rate of the different components comprising a multi-component complex fluid in a production lines are arranged as per claim 50, characterized in that said measurement is performed:
sequentially, for each production line, by means of an adequate program; or
simultaneously, measuring at the same time flow-rate and proportions of the complex fluid components in each production line and then adding same.

52. An arrangement of production lines for a multi-component complex fluid which uses the device according to claim 1, characterized in that a single sensor assembly is associated to an auxiliary production line unto which there converge the different production lines of the complex fluid.

53. An arrangement according to claim 52, characterized in that each of said production lines comprises an electronically commanded two-way two-position valve.

54. A method for the real time and direct measurement the proportion and flow-rate of the different components comprising a multi-component complex fluid in an arrangement of production lines according to claim 52, characterized in that said measurement is carried out by enabling passage of the complex fluid of each production line towards said single sensor assembly in a sequential manner under the control of said control computer at time intervals which shall be established as a function of the number of production lines connected to the auxiliary production line.
